(19) United States
(12) Patent Application Publication
(10) Pub. No.: US 2024/0362154 A1
(43) Pub. Date: Oct. 31, 2024

(54) SMART TEST CODE GENERATION

(71) Applicant: Nathan Shevick, Seattle, WA (US)

(72) Inventor: Nathan Shevick, Seattle, WA (US)

(21) Appl. No.: 18/766,625

(22) Filed: Jul. 8, 2024

Related U.S. Application Data
(63) Continuation of application No. 16/206,975, filed on Nov. 30, 2018.
(60) Provisional application No. 62/593,245, filed on Nov. 30, 2017.

(51) Int. Cl. G06F 11/36

(52) U.S. Cl. CPC G06F 11/3684; G06F 11/3664

(57) ABSTRACT

A smart test generation system is described herein that removes much of the burden of creating boilerplate or routine code from the developer. The system intelligently generates as much code as possible so that the developer can focus on what he or she wants the test to do, rather than spending time setting up the test's framework. The unit test code generated by the smart test generation system is extremely detailed and complete compared to past solutions for test code generation. Thus, the smart test generation system quickly and easily sets developers up to write unit test code by freeing the developer from writing boring and repetitive test framework and setup code.

### CROSS-REFERENCE TO RELATED APPLICATIONS

The present application is a continuation of U.S. patent application Ser. No. 16/206,975, entitled “SMART TEXT CODE GENERATION,” and filed on 2018 Nov. 30, which claims the benefit of U.S. Provisional Patent Application No. 62/593,245 (Attorney Docket No. SHEVICK001) entitled “SMART TEST CODE GENERATION,” and filed on 2017 Nov. 30, each of which is hereby incorporated by reference.

### BACKGROUND

Software engineers writing java code in certain industries organize their code into small, reusable components (classes). Each component usually takes all of its dependencies (other components) in the constructor and provides a public method that other components can use to perform certain tasks. IntelliJ IDEA is a Java integrated development environment (IDE) for developing computer software. It is developed by JetBrains (formerly known as IntelliJ), and is available as an Apache 2 Licensed community edition, and in a proprietary commercial edition. It provides an extension architecture that allows plugins with various features for helping developers during the coding process.

Engineers usually write the code for a component first, and then create unit-tests for it in a test-class. The test-class contains code that constructs an instance of the component (if needed), and a test-method for each public or package-local method in the component. The test-method invokes the method on the component and then verifies the method either returns the correct value or interacts with other components (its dependencies) correctly.

Engineers often create the unit-test for a given source-class by hand. This typically involves the following steps.
1. Create the package-folders in the test-sources directory that mirror the package-structure of the source-class; in the IntelliJ IDE the steps are: right-click the test-sources root directory and click New->Package, then type the package name.
2. Create the test class; the steps are: right-click the package-folder and click New->Java Class; Type the name of the source-class+“Test” and click OK. This will create the test-class and open it in the editor window.
3. Add any @RunWith annotations to the test-class declaration (usually copy/paste them from an existing unit-test).
4. Declare private member fields for the source-class's dependencies and annotate them with the Mockito @Mock annotation if needed; side note: most of the time, you use mocks for any mockable dependency that is not a common-type (e.g. List, Map, Set, etc.); using Mockito mocks is easier than creating a fake, or a subclass of the dependency whose public-methods return hard-coded data.
5. Declare private member fields for the source-class's non-mockable dependencies; a dependency is non-mockable if its type is one of the following: 1) declared to be final (a sealed class), 2) an array or primitive, 3) declared to be static, or 4) an enum.
6. Declare a member field for the instance of the source-class to be used in the test-methods.
7. Create a setup( ) method annotated with the Junit @Before annotation that does the following: a) initialize non-mockable dependencies to appropriate values, and b) use the member fields described in 4 and 5 to construct the instance of the source-class.
8. Create test-methods for each public and package-local method. Each test-method does the following.
   a. Declares local-fields for the method parameters.
   b. Adds Stub-code to configure the member fields containing mocks to return appropriate values when their methods are called; e.g. when (mockServiceAdapter.getUserById(any(String.class)).thenReturn(new User(“bob”)).
   c. Invoke the test method. Invoke the method on the member field containing the instance of the source-class.
   d. Verify the results. Verify the test-method returned the correct value (if it returns a value). Otherwise, verify that it interacted with the dependency in the correct way; i.e. if the method is called storeUser( ) verify that it called the storeUser( ) method on its dependency with the appropriate arguments.

Much of the above code is boilerplate code. It often takes 5-15 minutes to write depending on the size of the source-class. Writing this code is tedious and unfulfilling, which can lead to developers skipping the needed testing of their code altogether or doing a poor job due to the monotony.

### BRIEF DESCRIPTION OF THE DRAWINGS

FIG. 1 is a block diagram that illustrates components of the smart test generation system, in one embodiment.

FIG. 2 is a flow diagram that illustrates processing of the smart test generation system to search for and open a unit test, in one embodiment.

FIG. 3 is a flow diagram that illustrates processing of the smart test generation system to automatically generate a unit test, in one embodiment.

### DETAILED DESCRIPTION

A smart test generation system is described herein that removes much of the burden of creating boilerplate or routine test code from the developer. The system intelligently generates as much code as possible so that the developer can focus on what he or she wants the test to do, rather than spending time setting up the test's framework.

Using the smart test generation system, a user first selects any class within a project, and then invokes the system by selecting a menu item, entering a keyboard shortcut, or other method. The first time this is done, the system presents a user interface to the user and asks for some default configuration information that will be saved for future invocations of the system. On subsequent invocations of the system for the same class, the system will use the information captured the first time, and take the user directly to any existing unit test code previously generated. The first time user interface asks the user for a language to produce tests in (e.g., Java or Groovy), a velocity or other template to use to create unit tests (e.g., JUnit4Mockito.java.ft), the test sources root (directory where tests will be created), and other optional settings. After providing this information, the user can click an OK or other button to dismiss the user interface and prompt the system to create the unit tests for the selected class and options.

The unit test code generated by the smart test generation system is extremely detailed and complete compared to past solutions for test code generation. For example, in the unit test code, any dependencies of the class being tested are initialized to mocks unless non-mock actual objects are available (the system may be configured in some embodiments to select when mocks are used, for example, in one embodiment the system only uses non-mocks when the class is of a default, recognized type), and creates an instance of the class to be tested. The system also creates test methods for each public and package local and, in some cases protected, method in the class. In these test methods, the system initializes local variables needed to pass to the method being tested and verifies return values returned from the method being tested. The developer can later modify this code to specify different initialization values or a different expected return result. The initialization values preferred by the system are set to useful, readable, modifiable values rather than simply using null or other empty value. This allows the developer to quickly modify these values to something meaningful that will provide a valid test case. The system currently recognizes over 150 common types for which meaningful initialization values are selected and mocks are not needed.

Thus, the smart test generation system quickly and easily sets developers up to write unit test code by freeing the developer from writing boring and repetitive test framework and setup code. The system also smartly detects common design patterns and modifies the test code generated to provide useful boilerplate for each of these design patterns. For example, for a class having only static methods, the test code that the system generates will have test methods to test each of the static methods and will not instantiate the class or create a setup method because they are not needed in such a class. As another example, for a sealed abstract class having a private constructer and one or more static creator methods, the system generates test code to create the class using each of the static creator methods.

### Plugin Settings

The smart test generation system allows (sometimes requires) the user to specify which velocity template should be used to generate unit-tests at the project-level and/or at the module-level. This allows the user to generate a unit-test by performing one action (e.g., pressing ctrl+alt+k); i.e., the user does not have to select the template to use each time he/she generates a test; the user does not have to decide whether or not to create setup/teardown methods in the test; the user does not have to check boxes for each method he/she wants to create a test for. Note that the user may provide the Template and Test Sources Root directory settings the first time he/she generates a test in a project; this is described in more detail herein.

The smart test generation system allows (sometimes requires) users to specify where the system should create unit-tests for classes in a particular module. This is needed, because most modules have their own source directory and test-sources directory (or directories). In fact, the definition of a module, according to JetBrains's website is “a part of a project that you can compile, run, test and debug independently,” (see https://www.jetbrains.com/help/idea/about-modules.html). The system can automatically infer where it should create the unit-tests for a given module and configure the system Module Settings automatically for the user; that functionality is described further herein.

The smart test generation system offers the option to automatically configure the module-level settings (set the Test Sources Root directory for the module) for the user so that he/she does not have to specify it manually the first time he/she creates a test for a class in the module, in many cases. This is described in greater detail herein.

The smart test generation system opens the generated (or existing) test-class in an IntelliJ editor window. The user can configure which editor window the system will open the test-class in by setting the Application Setting: Open the test file setting. The options are as follows:
In the active editor window—the system will open the test-class in the active editor window (the editor window containing the source-class).
In the next editor window if one is available (this is the default option) —the system will open the test-class in the editor window next to the active editor window if one is available; otherwise, it will open the test-class in the active editor window.
In the next editor window, creating one if needed—the system will open the test-class in the editor window next to the active editor window if one is available; otherwise, it will create a new editor window by splitting the active editor window vertically and opening the test-class in the new window.

The system allows the user to quickly jump from a source-class to its unit-tests by pressing the keyboard shortcut (e.g., ctrl+alt+k) that is used to create a test-class. This works, because, before the system saves the generated test-class, it searches for an existing test-class with the same or similar canonical-name as the generated test-class and opens it if it finds one (instead of saving the generated test-class); the search algorithm is described in greater detail herein.

The system includes default templates to generate unit-tests using common test-runners and mocking frameworks: Junit4Runner with Mockito (Junit4Mockito.java.ft), Junit5 with Mockito (Junit5Mockito.java.ft), RobolectricTestRunner with Mockito (Robolectric3Mockito.java.ft), and AndroidJUnit4 runner with Mockito (AndroidJUnit4Mockito.java.ft). The system includes a version of each template that generates the corresponding test in Groovy as well: Junit4Runner with Mockito (Junit4Mockito.groovy.ft), Junit5 with Mockito (Junit5Mockito.groovy.ft), RobolectricTestRunner with Mockito (Robolectric3Mockito.groovy.ft), and AndroidJUnit4 runner with Mockito (AndroidJUnit4Mockito.groovy.ft).

### System Level

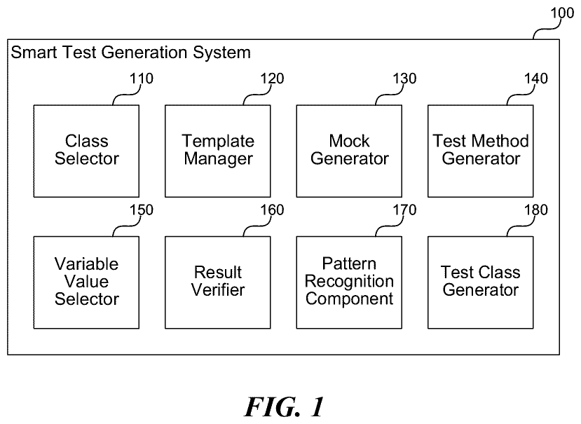

FIG. 1 is a block diagram that illustrates components of the smart test generation system, in one embodiment. The system 100 includes a class selector 110, template manager 120, mock generator 130, test method generator 140, variable value selector 150, result verifier 160, pattern recognition component 170, and test class generator 180. Each of these components is described in further detail herein.

The class selector 110 receives a selection of a subject source code class within a project for which the developer wants to generate test code in a test class. The selection may come via a menu item, keyboard shortcut, or other method. The first time the developer selects a class and invokes the system 100, the component 110 displays a user interface to receive default configuration information for future invocations of the system 100. The configuration information may include a language in which to generate test code, a template to use to create tests, the location to store tests, and other settings. When the developer later selects the same subject class, the component 110 will use previously set default configuration information and display to the developer any previously generated test class for the subject class.

The template manager 120 presents one or more templates to the developer for generating the test class. The template may contain default information, formatting for the test class, and other information used to create the test class. The templates may be velocity or other templates and may be modified by the developer to affect how future test classes are generated. The template manager 120 may store the developer's selection of a template and use that selection without asking the developer upon subsequent invocations of the system 100 to generate additional test classes.

The mock generator 130 identifies dependencies of the selected class, determines which dependencies have non-mocks available, and initializes mocks for those dependencies that do not have non-mocks available. The mocks are initialized to take the place of dependencies that are normally called during operation of the code being tested to provide well determined responses from the dependencies to test the code of the selected class. In some embodiments, configuration information determines when mocks are used, such as when the class is not of a default, recognized type.

The test method generator 140 creates test methods for subject methods in the selected subject class. The subject methods for which the system 100 creates test methods may include each public, package local, and protected method of the subject class, or some subset of these. The system 100 enumerates the subject methods by inspecting the subject class, identifies relevant qualities of the subject methods, and determines which subject methods can be invoked and tested by the system 100.

The variable value selector 150 initializes local variables in each created test method needed to pass to the subject method being tested. The system 100 selects values for the local variables that are useful, readable, modifiable values. This reduces the burden on the developer to pass meaningful values to the subject method rather than empty or null values that would not exercise functionality of the subject method as thoroughly. The developer can modify the initialized values to make the test exercise the functionality intended by the developer for that test. The system 100 recognizes over 150 common types for which meaningful initialization values are selected.

The result verifier 160 generates code in the test method to verify output from calling the subject method. The subject method is like a black box, with the variable value selector providing meaningful input to the black box and the result verifier verifying that an expected result comes out of the black box. The result may be in the form of return values, an outside impact of calling the subject method, values passed to mocks that show that the subject method is doing the right thing, and so forth.

The pattern recognition component 170 recognizes patterns in the test code and applies the recognized patterns when generating test code to adhere to the recognized patterns. For example, for a subject class with only static methods, the system 100 recognizes there is no need to instantiate the subject class before invoking the static methods to test them. As another example, for a sealed, abstract subject class having a private constructor and one or more static creator methods, the system recognizes that the creator methods should be used to create an instance of the subject class for testing and generates code to do so.

The test class generator 180 generates the test class by writing the test code that results from generating test methods into source code files representing test cases. The test class generator sets a developer up to write unit tests without having to perform a lot of tedious setup or boilerplate code generation. Rather, the developer can focus on the meaningful and unique aspects of each test case. The system 100 recognizes that a project may have multiple test roots and stores generated test classes in a location selected by the developer or automatically selected by the system 100. This location may be module-centric, so that the system 100 stores a location to use for the test root of each module in a project.

The computing device on which the smart test generation system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Template Data Model Expansion

The Template Data Model is the data model available to the Velocity templates that are used to create the test-class; this comprises variables describing the source-class; i.e. its methods, fields, etc. Both the JUnitGeneratorV2 and TestMe plugins have a data model. TestMe has, by far the most thorough data model of the existing plugins.

The system exposes additional information about the source-class to the velocity-templates that the other plugins do not expose in their data models. The full data model is described in below in Appendix—Template Data Model. The key pieces of additional information exposed by the system but not by the other plugins are described below.
A property containing the longest constructor with at least package-local (public, protected or package-local) access: SourceClass.preferredConstructor. The TestMe plugin data-model gives the template the list of methods in the source-class, which includes all constructors. To find the preferred constructor, the developer would need to update the velocity code to search all of the constructors.
Information about annotations on the source-class and its constructors, fields and methods: 1) SourceClass.dependencyAnnotatedFields—this contains a list of fields in the source-class that have one or more dependency-annotations (@Inject or @Autowired), and 2) ClassMember.dependencyAnnotated—This returns true if the ClassMember contains a dependency-annotation.
Variable (a class used to describe a member-field or a method or constructor parameter) has properties containing names the test-class should use when storing its value in a local-field or test-class member-fields. The fields are: 1) Variable.testClassMemberName—Details about how this is computed are described herein, and 2) Variable.testClassLocalFieldName—Details about how this is computed are described herein. Storing the test-class member name in the Variable allows the template-code to refer to the same property when declaring a member-field to hold the value for the Variable and when using it in a constructor or method call; e.g. the template-code declares a member-field with name: Variable.testClassMemberName, then when it needs to invoke the constructor, it uses Variable.testClassMemberName as the method-parameter; this ensures it uses the same name to both declare the variable and refer to it later. The same concept applies for Variable.testClassLocalFieldName.
The SourceClass contains similar fields for storing the name of the class to use in the test-class member-fields and local-fields: SourceClass.testClassMemberName and SourceClass.testClassLocalFieldName.
Additional fields in Variable are described in the next sections.

### Template Data Model Mutable Fields

The system makes several fields in the data model mutable so that users can modify them in their template-code. This allows users to configure the data-model in the template-code before rendering the test-class; e.g. the developer could call a velocity-macro at the start of the velocity-template code that configures certain Variables (e.g. constructor parameters) in the data-model to use specific names for their corresponding test-class member-fields. The default templates included with the system use this extensively as described in the next section: Default Velocity Template Architecture and its subsections.

The mutable fields are as follows:

| Property Name | Type | Description |
|---|---|---|
| SourceClass.testClassMemberName | String | Mutable field containing the name of the member used to |
| | | store an instance of the source class. The default value is |
| | | determined by the IDE code-style settings (provided by the |
| | | IntelliJ JavaCodeStyleManager.suggestVariableName( ) API). |
| SourceClass.testClassLocalFieldName | String | Mutable field containing the name of the local-field used to |
| | | store an instance of the source class (if needed). The default |
| | | value is determined by the IDE code-style settings (provided by |
| | | the IntelliJ JavaCodeStyleManager.suggestVariableName( ) API). |
| SourceClass.preferredConstructor | Constructor | Mutable field that, by default, contains longest constructor |
| | | (constructor with the most arguments) with at least package- |
| | | local access or higher (Public, Protected or Package Local). |
| Variable.testClassMemberName | String | For ClassMembers, this is the same as the Variable.declaredName; |
| | | for method-parameters, this is determined based on the |
| | | declaredName and the output of the IntelliJ |
| | | JavaCodeStyleManager.suggestVariableName( ) API. |
| Variable.testClassLocalFieldName | String | For method-parameters, this is the same as the declared-name. For |
| | | ClassMembers, this is determined based on the declared-name |
| | | and the output of JavaCodeStyleManager.suggestVariableName( ) API. |
| Variable.initExpression | String | This is an alias for Variable.type.initExpression. |
| Variable.shouldBeMocked | boolean | This is an alias to Variable.type.shouldBeMocked |
| Variable.shouldStoreInReference | boolean | Set to true by default; this may be modified by logic in the |
| | | template code based on the Quick Settings. |
| Type.initExpression | String | Set to Type.defaultInitExpression by default. The |
| | | defaultInitExpression is a java expression used to obtain an |
| | | instance of the class or “null” for types that are not recognized |
| | | Common Types. |
| Type.shouldBeMocked | boolean | This is set to false when the type is a recognized Common Type. |
| | | For other types is set to true if the type is mockable and |
| | | false otherwise. |

### Default Velocity Template Architecture

The architecture for the default velocity templates is novel and unlike any of the existing products. In fact, using velocity in this way is considered an anti-pattern for its more traditional use-cases like converting a data model into an HTML page.

The default templates are carefully designed to achieve the following goals.
1. Allow developers to easily configure common aspects of the generated test-class; e.g. make all test-class members containing mocks start with the prefix: mock.
2. Keep the actual code that renders the test-class (described in the section: Rendering the Test Class) as simple and easy-to-read as possible so that developers who have never worked with Apache Velocity can understand and modify it.
3. Enable power-users to change any aspect of how the test-class is generated.

Each default-template included with the system is organized into 5 parts. The parts are described below in the order in which they appear in the default-templates. The source-code for one of the default templates, JUnit4Mockito.java.ft, is included in the Appendix in Appendix: Default Template: JUnit4Mockito.java.ft for reference and example.

### Quick Settings

Each default template included with the system has Quick Settings, or variables set at the top of the file that the developer can use to customize code-style and other settings in the generated test-class. The Quick Settings include the following options.
Use a special prefix for test-class members containing dependencies (for the source-class)
Use a special prefix for test-class members containing dependencies that contain mocks
Use a special prefix for local-fields containing test-method parameters
Use a special prefix for local-fields containing test-method parameters that contain mocks.
Customize the name of the member or local-field used to store the instance of the source class.
Use static imports for the Mockito initMocks method and related methods.
Use mocks for mockable parameters whose names end in “listener” or “callback”, ignoring case.
Use custom initialization expressions for dependencies and test-method arguments of certain types. This is particularly important, because some of the ideas in the Looking to the Future section build upon it.

The Quick Settings variables are described in the table below.

| Name | Type | Description |
|---|---|---|
| $dependencyMemberNamePrefix | String | An optional prefix that will be used for all test-class |
| | | members that contain dependencies for the source class. |
| $mockDependencyMemberNamePrefix | String | Similar to $dependencyMemberNamePrefix but only applies |
| | | to test-class members containing dependencies that are |
| | | satisfied with mocks. |
| $parameterLocalFieldNamePrefix | String | An optional prefix that will be used for local-fields that |
| | | contain arguments for test-methods. |
| $mockParameterLocalFieldNamePrefix | String | Similar to $parameterLocalFieldNamePrefix but only applies |
| | | to local-fields containing mocks. |
| $sourceClass.testClassMemberName | String | The name of the member used to store an instance of the |
| | | source class. The default value is determined by the IDE |
| | | code-style settings. |
| $sourceClass.testClassLocalFieldName | String | This is similar to $sourceClass.testClassMemberName, but is |
| | | used when storing an instance of source class in a local- |
| | | field in the test-class. |
| $useStaticImportForInitMocks | boolean | This specifies whether or not MockitoAnnotations.initMocks |
| | | and related methods should be imported with static-imports. |
| $useMocksForListenerAndCallbackParameters | boolean | If set to true, the template will use mocks for any mockable |
| | | method parameter that ends in “listener” or “callback”, |
| | | ignoring case. |
| $initExpressionOverrides | Map<String, | This sets custom initialization expressions for dependencies |
| | Map> | and method-parameters of certain types. The key is the |
| | | canonical name of the type. The value is a Map containing |
| | | the following keys and values: |
| | | initExpression - A String containing a Java expression that |
| | | evaluates to an instance of the type. |
| | | importsRequired A List<String> containing the import lines |
| | | required for the initExpression. |
| | | shouldStoreInReference A boolean indicating whether or not |
| | | the value of the initExpression should be stored in a |
| | | reference (local field or test-class member) or used inline |
| | | when needed. |
| | | The example below specifies that dependencies and method- |
| | | parameters of type android.content.Context should have value: |
| | | RuntimeEnvironment.application and that the expression |
| | | RuntimeEnvironment.application should be used inline wherever |
| | | the dependency is needed rather than stored in a local-field |
| | | or a test-class member-field. |
| | | #set($initExpressionOverrides |
| | | [“android.content.Context”] = |
| | | {“initExpression”: |
| | | “RuntimeEnvironment.application”, |
| | | “importsRequired”: [“import |
| | | org.robolectric.RuntimeEnvironment;”], |
| | | “shouldStoreInReference”: false}) |

Call the initializeTemplateDataModel( ) Macro

The default-templates call the initializeTemplateDataModel( ) macro immediately after the Quick Settings section. Calling the macro does several things; those are described below; note that the implementation for the initializeTemplateDataModel macro is defined below.

The macro updates mutable fields on the data model based on Quick Settings described above; e.g. it updates each Varaible.initExpression, Variable.shouldBeMocked, Variable.testClassMemberName, Variable.testClassLocalFieldName and Variable.shouldStoreIn Reference based on the Quick Settings: $initExpressionOverrides, $dependencyMemberNamePrefix, $mockDependencyMemberNamePrefix, $parameterLocalFieldNamePrefix, $mockParameterLocalFieldNamePrefix, $useStaticImportsForInitMocks and Variable.type.mockable.

The initializeTemplateDataModel macro looks at the source-class's methods, constructors, fields, annotations, super-types, etc., and sets global variables describing how to render the test-class. These global variables are used in code below, which actually renders the test-class. The patterns initializeTemplateDataModel detects and the global variables it sets are described below.

The system detects various patterns in the source-class:
Singleton
Enumeration.
Class containing a public or package-local constructor with at least one argument; this is the most common case; it's the case where the source-class takes all of its dependencies in the constructor.
Class a with no-args, package-visible constructor and package-visible dependency-annotated fields; dependency-annotated fields are fields annotated with @Inject or @Autowired.
Class with a no-args, package-visible constructor and private, dependency-annotated fields
Class that has no package-visible constructor but does have static creator methods like parse( . . . ) or from( . . . ); i.e. the sealed abstract class and similar patterns.
Class containing only static methods; e.g. a Utils class like StringUtils.
Android activity (Robolectric3 and AndroidJUnit4 templates only)

The macro sets the following variables for the test-class rendering code (in the next section) to use. The variables are set based on the pattern detected previously.

| Name | Type | Description |
|---|---|---|
| $dependencies | List<Variable> | Contains all fields the test-class should provide for the |
| | | instance of the source-class. |
| $memberFields | List<Variable> | A subset of $dependencies containing all fields that |
| | | should be stored in members in the test-class. |
| $mockMemberFields | List<Variable> | A subset of $memberFields containing only fields that |
| | | should be mocked. |
| $nonMockMemberFields | List<Variable> | A subset of $memberFields containing all fields that |
| | | should not be mocked. |
| $sourceClassMemberNeeded | boolean | A boolean indicating whether or not an instance of the |
| | | source-class should be created and stored in a member |
| | | of the test-class. |
| $shouldUseInjectMocks | boolean | True if the @InjectMocks annotation must be used to inject |
| | | dependencies into the instance of the source-class. |
| $shouldSetPackageLocalFields | boolean | a Boolean indicating whether or not the test-class should |
| | | provide dependencies to the source-class by setting |
| | | package-local fields directly |
| $mocksNeeded | boolean | True if the source-class has at least one dependency that |
| | | should be mocked. |
| $shouldCreateTestsForInstanceMethods | boolean | A Boolean indicating whether or not tests should be created |
| | | for instance methods in the source-class. |
| $androidActivity | boolean | This is only set in the Robolectric3 and AndroidJUnit4 templates. |
| | | This is true if the source-class is an Android Activity. |

### Rendering the Test Class

This section contains the code that actually renders the test-class. This code outputs the package declaration statement; e.g. “package com.myapp”, the test-class declaration, the code that declares member-fields for the source-class and its dependencies (if needed), including the setup( ) method, test-methods, etc. This code is designed to be easy to read, understand, and modify.

### Helper Macros

These are macros used by the rendering code in the previous section. Users should create their own macros here if needed.

The initializeTemplateDataModel( ) Macro Implementation

This is the implementation of the macro that performs the tasks described in “Call the initializeTemplateDataModel( ) Macro” above. Power users can customize this to add or change global variables that are available to the code in “Rendering the Test Class” above.

### System Functions

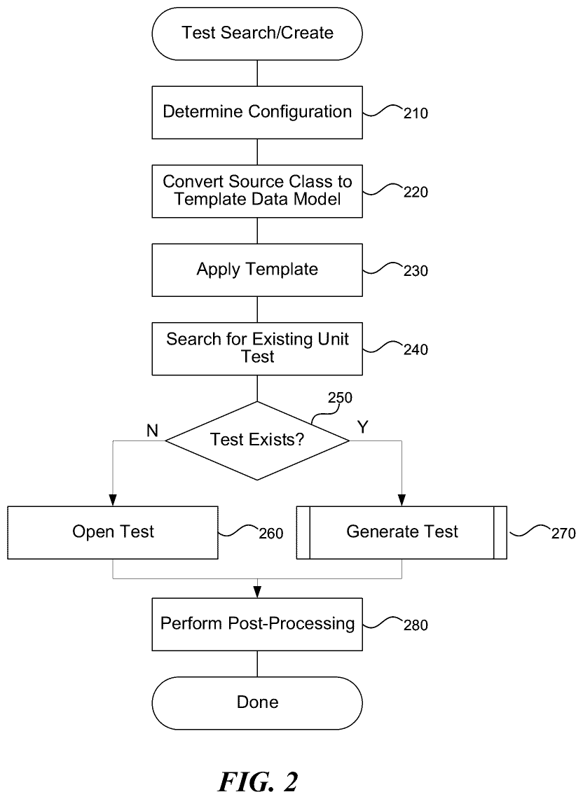

FIG. 2 is a flow diagram that illustrates processing of the smart test generation system to search for and open a unit test, in one embodiment. Beginning in block 210, the system accesses configuration information to determine settings provided by a developer for modifying how tests are automatically generated. The configuration information may contain a test sources root location, a template to use for generating tests, and other information that determines how the system generates tests.

Continuing in block 220, the system creates the template data model from the selected source class to make source class information accessible to a template. The template data model may include enumerating the methods of the source class, identifying publicly accessible data members, and so forth.

Continuing in block 230, the system applies the template to automatically generate test code based on the accessed configuration information. The template may specify formatting information, order of various parts of the test, which dependencies are mocked, and so on.

Continuing in block 240, the system searches for an existing, previously generated test associated with the selected source class. The system may search a configured test sources root or other location for a file or other data that contains test source code. If the developer has previously requested that the system generate a test, then the system will find it and present the existing test to the user. If the system detects that an existing test already exists for the source class (even if created by a different system), the system will find it and present the existing test to the user. Otherwise, the system will automatically generate a new test class for testing the source class.

Continuing in decision block 250, if the system found an existing test, then the system continues at block 260 to open it, else the system continues at block 270 to generate the test for the first time.

Continuing in block 260, the system opens the existing, previously generated test. The test may include previous automatically generated code, as well as edits added by the developer to flesh out one or more test cases.

Continuing in block 270, the system saves the generated test to a test sources root location. The test is generated with one or more of the features described herein, such as mocking dependencies, initializing variables to reasonable values, generating test methods for each source method, and so forth.

Continuing in block 280, the system performs any post-processing on the generated test. Post-processing may include formatting the generated code, and so on. Post-processing involves cleaning up the generated code as described further herein. After block 280, these steps conclude.

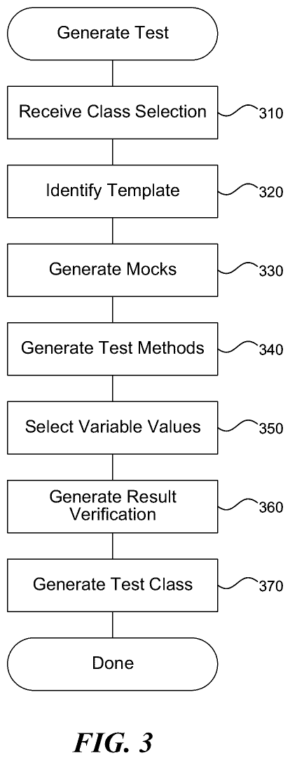

FIG. 3 is a flow diagram that illustrates processing of the smart test generation system to automatically generate a unit test, in one embodiment. Beginning in block 310, the system receives a selection of a subject class for which a developer wants to generate test code in a test class automatically. The developer may select the subject class in a graphical user interface, console, or other input mechanism. If this is the first time the developer has tried to generate a test class for this module, then the system may request that the user provide configuration information that will be used to generate this and subsequent unit tests.

Continuing in block 320, the system identifies a template to use for generating test code. The template may provide default information, formatting for the test class, and other information used to create the test class. The templates may be velocity or other templates and may be modified by the developer to affect how future test classes are generated. The system may store the developer's selection of a template and use that selection without asking the developer upon subsequent invocations of the system to generate additional test classes.

Continuing in block 330, the system identifies dependencies of the selected class, determines which dependencies have non-mocks available, and initializes mocks for those dependencies that do not have non-mocks available. The mocks are initialized to take the place of dependencies that are normally called during operation of the code being tested to provide well determined responses from the dependencies to test the code of the selected class. In some embodiments, configuration information determines when mocks are used, such as when the class is not of a default, recognized type.

Continuing in block 340, the system creates test methods for subject methods in the selected subject class. The subject methods for which the system creates test methods may include each public, package local, and protected method of the subject class, or some subset of these. The system enumerates the subject methods by inspecting the subject class, identifies relevant qualities of the subject methods, and determines which subject methods can be invoked and tested by the system.

Continuing in block 350, the system selects variable values in each created test method needed to pass to the subject method being tested. The system selects values for the variables that are useful, readable, modifiable values. This reduces the burden on the developer to pass meaningful values to the subject method rather than empty or null values that would not exercise functionality of the subject method as thoroughly. The developer can modify the initialized values to make the test exercise the functionality intended by the developer for that test.

Continuing in block 360, the system generates code in the test method to verify output from calling the subject method. The subject method is like a black box, with the variable value selector providing meaningful input to the black box and the result verifier verifying that an expected result comes out of the black box. The result may be in the form of return values, an outside impact of calling the subject method, values passed to mocks that show that the subject method is doing the right thing, and so forth.

Continuing in block 370, the system generates the test class with the created test methods, selected variable values, and generated output verification code. The system stores the test class in a test sources root or other location selected by the developer or automatically by the system. After block 370, these steps conclude.

### Default Types

The system uses default-types for test-class members and local-field of common-types that developers either cannot mock (because they are static, final, enumeration-types or arrays) or usually don't want to mock; e.g., java.util.Map, java.util.Set, etc. To do this, the system maintains a mapping of canonical names to initialization-expressions in a JSON file in its resources directory. This mapping includes common types in the core java packages (java.util, java.lang, java.time, java.text, etc.), as well as core packages in the Google Guava, Apache Commons Lang and RxJava libraries; this list will grow in the future. A sample of the defaulttypes.json file is included in the Appendix herein.

The system also selects values to use for the default-types based on libraries available on the test-classpath; e.g. if the type has canonical name: java.util.concurrent. Executor and Google Guava is available on the test-classpath, the system will use expression: MoreExecutors.directExecutor( ) (using the class from: com.google.common.util.concurrent.MoreExecutors) for the value. Test-classpath is the java class-path containing all dependencies required to run the unit-tests for a given module. This particular piece of functionality is not available in TestMe or JUnitGeneratorV2.

### Test Generation

The user can invoke the Generate Test action by opening a Java class (source-class) in the IntelliJ Editor Window and doing one of the following.
Select SquareTest->Generate Test from toolbar.
Press the keyboard shortcut; e.g., ctrl+alt+k on Windows/Linux.

The system determines the 2 pieces of information needed to create the unit-test for the source-class. Those are:
1. The Velocity Template to use to generate the unit-test.
2. The Test Sources Root directory in which to save the generated unit-test.

The first time the user invokes the Generate Test Action, the system shows a dialog window prompting him/her to select the options described below; the dialog is called the JIT Config Dialog.
1. Test Language: the programming language the user would like to create his/her tests in (the system supports Java and Groovy);
   a. This option filters the items shown in the dropdown list for the next item (Template); i.e. if you select Java as the Test Language, the system will only show Java templates in the Template dropdown list.
2. Template: the template the system will use to create the test-class; the user can select from one of the default-templates or from one of the system's Java or Groovy Templates he/she has previously created; note that a Java-Template is a template that produces a test-class in Java while a Groovy-Template is a template that produces a test-class in Groovy. Upon selecting a template, the UI expands to show the template text and allows the user to modify the text and save a copy.
3. Test Sources Root: The test-sources root is the directory in which the system will create the unit-test-file and any folders required to follow the package-structure of the class for which he/she is generating the test. The combo box is prepopulated with directories the system identifies as possible unit-test source directories for the module containing the source-class that the user has invoked the Generate Test action for.
4. Promote template settings to project settings: The system can store the Template and Test Language the user selected in the options described above as the System Project Settings for the project he/she is currently working in; when checked, this stores the user's Test Language and Template selection as default settings for all modules in the project; This allows the system to offer the option to configure settings for the user's other modules automatically the first time he/she invokes the Generate Test action for a file in them; the details for this are described in the next sections. The Promote template settings to project settings checkbox is checked by default.
5. Module Configuration
   a. Option: Automatically configure when possible
      i. The system will try to automatically configure the settings for a module the first time the user invokes the Generate Test Action for a file in it. The details describing when the system can configure the settings automatically are described in Project Settings Contain Test Language and Template but no Test Sources Root.
   b. Option: Always ask to configure module settings
      i. The system will prompt the user (show the dialog window) to configure settings for the module the first time he/she generates a test for a class contained in it.

The system checks the System Project Settings and System Module Settings to see if the following are specified.
1. Test Language (from project settings or module settings)
2. Template (from project settings or module settings)
3. Test Sources Root (from module settings)

If all are specified, the system moves on to the next step. Other cases are described in the sections below.

If the System Project Settings contain the Module Configuration option: Automatically configure when possible, the system will attempt to automatically configure the System Module Settings; i.e. set the Test Sources Root in the module settings automatically for the user. The system will automatically configure the System Module Settings (set the Test Sources Root) for the module if one of the following is true.
The module contains exactly one unit-test-sources-root, and the unit-test-sources-root either contains source-files matching the language used in the Template (Java or Groovy) in the System Project Settings (the most common scenario) or is named in a way that the system assumes it intends to hold files matching said language; e.g. the directory is named “java” or “javatests” and the language used in the Template is Java. A unit-test-sources-root is a directory that the system identifies as a test-sources root (a directory returned by the com.intellij.testIntegration.createTest.CreateTestAction.compute TestRoots (module) API) that does not contain the name “integration” or “integrationTest”.
The module contains exactly one Groovy-unit-test-sources-root and the System Project Settings contain a Groovy-Template. Groovy unit-test-sources-root is a unit-test-sources-root that either contains groovy files or is named in a way that one can assume it intends to hold Groovy files; e.g. “groovy” or “groovytests”, ignoring case.
The module contains exactly one Java-unit-test-sources-root, the System Project Settings contain a Java Template and the module does NOT contain a Groovy-unit-test-sources-root; the rationale is: if the module contains a Groovy-unit-test-sources root, the developer or team may have started writing tests in Java, then switched to using Groovy; the system should show a prompt to determine the correct settings to use. Java unit-test-sources-root is the same as Groovy unit-test-sources-root, but replace “groovy” with “java” in the description.
The module's dependent modules collectively contain exactly one test-sources root and that test-sources root contains source-files matching the template-language in the project-settings or is named in a way that the system assumes it intends to hold files matching said language.

The goal for the feature: Module Configuration: Automatically configure when possible is to avoid showing the JIT Config Dialog and asking the customer to specify the Test Sources Root the first time he/she generates a test for the first time in a module in the same project; this helps customers working on projects that contain modules that use the same unit-test framework and have only one test-sources-root (a common scenario) save time.

This improves upon the design of the TestMe plugin, which tries to infer which test-sources root to create the unit-test in and does not give the user the option to choose one. This also improves upon the design of the JUnitGeneratorV2 plugin by 1) allowing the user to specify test-sources roots at the module-level, and 2) automatically inferring (configuring the Module Settings) for the user in many cases.

The system shows the JIT Config Dialog in all other cases, as the user will need to select the appropriate Test Sources Root and possibly specify a different Template to use for the module.

The system also checks to see if the settings specified in the System Project Settings and System Module Settings are valid and shows the JIT Config Dialog if they are not. Invalid settings mean situations like the following:
The Test Sources Root specified in the System Module Settings is no longer present on the file system (the folder has been deleted).
The Template specified in the System Module Settings or System Project Settings does not exist (the user deleted the template via the IntelliJ Templates Manager or by deleting the template file from the filesystem).

The system converts the source class into the template data model. The data model is a collection of variables available to the Velocity template that is used to create the test-class. The variables are as follows.

| Name | Type | Description |
|---|---|---|
| $sourceClass | SourceClass | Describes the class for which the |
| | | test is being generated. See |
| | | Appendix: Template Variable Types |
| | | for details. |
| $importsRequired | Set<String> | Import lines required by various |
| | | components in the SourceClass |
| $StringUtils | StringUtils | The StringUtils class from the |
| | | Apache Commons Lang 3 library. |
| $CodeStyleUtils | CodeStyleUtils | The CodeStyleUtils class provides |
| | | methods for obtaining recommended |
| | | names for fields based on the IDE |
| | | code-style settings. See Appendix: |
| | | Template Variable Types for details. |

The system invokes the Velocity Engine with the following.
A VelocityContext containing the data model described above.
The Template from the Determine Configuration section

This generates a Java or Groovy file containing the test-class. If an exception was thrown while running the Velocity Engine, the system shows a dialog window with the stacktrace and exits the flow.

The system searches the Project test-sources for a file with the same or similar canonical-name as the top-level class in the generated test-class. If one is found, the system opens it and exits the flow. A similar-name is the canonical-name of the test-class+/−an ‘s’ at the end; e.g. if the test-class is com.myapp.FooTest, the similar-name file would be com.myapp.FooTests; if the test-class is com.myapp.FooTests, the similar-name would be com.myapp.FooTest. Note that the generated Groovy file may contain multiple top-level test classes; in this case, the system uses the first class's canonical-name for the search.

The system saves the generated test-class in the Test Sources Root directory from the Determine Configuration section. The system creates package-folders in the Test Sources Root as needed to match the package declaration statement in the test-class; e.g. if the test-class has package-declaration statement: package com.myapp.foo The system will create folders com/myapp/foo in the Test Sources Root if they are not already present; it will then save the test-class in com/myapp/foo.

The system performs several post-processing tasks on the generated test-file to clean up and organize the code according to the user's code style settings. These are as follows.

The system uses IntelliJ's JavaCodeStyleManager.shortenClassReferences(file) API to convert the fully qualified references in the generated test-file to use import statements instead of fully qualified names. This is necessary, because the default velocity templates included with the system use fully qualified names when declaring local variables, member variables, etc. The default velocity templates do this for a number of reasons that are outside the scope of this document.

The system uses the IntelliJ GroovyImportOptimizer.processFile( ) API or the JavaCodeStyleManager.optimizeImports(file) API, depending on which language the test-class uses, to organize the imports according to the user's code-style settings. This is necessary, because the default templates add import statements in an arbitrary order.

The system invokes the IntelliJ CodeStyleManager.reformatText( ) API on the entire file. This is needed, because the velocity templates are indented according to velocity directives and the java code to help keep the template-code readable; this produces extra indentation in the generated java code.

The system does the following to remove extra newlines in the generated test.
Replace any whitespace element with three or more newlines with a new whitespace element containing two newlines.
Remove all but one newline at the end of the file; i.e., remove all but one newline after the last “}” in the top-level class in the test-file.

### Enhancements

The following paragraphs describe additional enhancements to the smart test generation system.

### Automatically Generate Mockito Stubs in the Test Methods

We can update the system's code to automatically generate Mockito stubs in the generated test-methods. An example of this is available in Appendix: Stub Example. This involves the following steps and components.

Detect where each ClassMember in the source-class (SourceClass.fields) could have gotten its value from. The system needs to store a link between constructor-parameters in public/package-local/protected constructors and the ClassMembers they are stored into. The system also needs to store a link between parameters in public or package-local setter-methods and the ClassMembers they are stored into in the method-bodies. The system can do this by giving each ClassMember a property called potentialSource Variables that contains a List<Variable> that contains references to the parameters (Variable objects in Method.parameters) mentioned above. Note that a ClassMember's potentialSourceVariables list will include itself if it is non-final and has a dependency-annotation or package-local access. Call any ClassMember that has a non-empty list of potentialSourceVariables a dependencyMember for future reference in this document.

Detect which dependencyMembers might be interacted with when an instance-method in the source-class is called. The system can use static analysis to detect which dependencyMembers in the source-class might be interacted with when a given instance-method in the source-class is called by doing the following. Let source-method be an instance method in the source-class (Method in the template data model). The system can analyze the code in the source-method to see which dependencyMembers it interacts with; it can do this by analyzing the statements and expressions in the source-method body to see if they call instance-methods on any of the dependencyMembers; it also analyzes the code of methods that are called in the source-method's code to see if they interact with any dependencyMembers, and so on and so forth.

The system can collect descriptions of each interaction with a dependencyMember; call these DependencyInteractions for future reference in this document. Each DependencyInteraction will contain the following properties.
1. A reference to the dependencyMember, called dependencyMember
2. A reference to the Method (the Method type from the Appendix: Template Variable Types described in this document, updated to include a list of checked-exceptions the method declares to be thrown) on the DependencyMember that source-method calls; call this dependencyMethod.
   a. Note that this also requires the system to give each field in SourceClass.fields a property containing the List<Method> it has.

The DependencyInteractions will be stored in a property of Method; i.e. the Method class will have a field called dependencyInteractions that contains a List<DependencyInteraction>.

Have the test-method created for a source-method contain stub-code for each DependencyInteraction in the source-method. The system default-templates can then generate stub-code in the “/Setup” section of each generated test-method; the stub-code contains stubs for each DependencyInteraction in the test-method's corresponding source-method. The stub-code will be generated based on the signature of each DependencyInteraction.dependencyMethod. See Appendix: Stub Example and Appendix: StubExample—With DependencyInteraction stubs for an example.

Note: to generate the stub-code, the template rendering-code must determine which Variable in a given Method.dependencyInteraction.dependencyMember.potentialSourceVariables list was used to provide the dependency to the instance of the source-class created in the test-class; it needs this to know how to refer to the member-field declared in the test-class to use it in the stub-code (e.g. mockDataStore in Appendix: StubExample—With DependencyInteraction stubs). The template-code will determine which Variable in a given ClassMember.potentialSourceVariables was used to provide the value for the ClassMember by checking to see which one is in its $dependencies list (set by the #initializeTemplateDataModel macro, described in this document).

Generate multiple test-methods for a source-method that interacts with one or more DependencyMembers that throw one or more checkedExceptions. The system uses the above technique to determine which DependencyMembers a given source-method interacts with. The template-code can then do the following when creating test-methods for a given source-method.
1. For each DependencyInteraction in source-method (Method)
2. For each checkedException listed in DependencyInteraction.dependencyMethod.checkedExceptions do the following
3. Create a test-method called: test [IntanceMethodName]_[DependencyInteraction.dependencyMember.declare dNameWithoutPrefix]Throws [checkedException.name]( )
   a. The test-method will contain all of the code it contains today.
   b. The test-method will add stub-code that causes the mock for the dependency used in the DependencyInteraction to throw an exception when the method in the DependencyInteraction is called.

See Appendix: Stub Example and Appendix: StubExample—With tests for exceptions thrown by DependencyInteractions for an example.

### Expand to Other Java IDEs Like Eclipse

It is possible to port the system plugin to other Java IDEs or IDEs that support java development. This involves creating a plugin for the Eclipse IDE that provides the same or similar functionality as the IntelliJ Plugin. The system currently works in some IDEs that are based on IntelliJ IDEA (e.g., Android Studio), but can also work in others that are used by developers.

### Expand to Other Programming Languages

It is possible to implement a plugin for the Visual Studio IDE that provides similar functionality to the system, but for C# code. The C# language is very similar to Java. Making a C#-version of the system would mostly involve replacing components with their .NET equivalent; e.g. replace Mockito with Moq4.

It is possible to update the system to generate tests for source classes written in Groovy or Kotlin. Groovy and Kotlin are both similar to java and both compile to java bytecode and run on the JVM. Creating an analogous version of the system to create tests for them is possible.

Global Variables in initializeTemplateDataModel( ) macro

Expand the logic to determine the class-architype and set the global variables to consider the following.
1. Whether or not the source-class includes setter-methods annotated with @Inject or @Autowired; the system could use these to provide dependencies to the source-class.
2. Whether or not the source-class “looks like a Java Bean”; i.e. whether or not its name contains “Bean” and/or it only has a public, no-arguments constructor, and setters for all of its private fields. The system will expose this information to the velocity-template code and the velocity-template-code in the default-templates will use it to determine how to set the dependencies in the instance of the source-class.
3. Whether or not the source-class or its properties (methods, fields, etc.) have data-serialization-annotations. Data-serialization-annotations are annotations on either the source-class or one or more of its properties (fields, methods, . . . etc.) that indicate it is intended to be serialized and deserialized; e.g. this will include annotations from the FasterXML/Jackson-annotations library like @JsonProperty; this will include annotations from JAXB like @XmlElement. This will grow to include annotations from many JSON/XML/YAML, etc. serialization libraries.
4. Any other annotations on the source-class or its properties and descendant-properties.

### Feature: Offer to Create a Template Based on the User's Existing Unit-Tests

When the user invokes the system for the first time in a Project or in a Module, the system will offer to scan the existing unit-tests in one of the user's unit-test-sources-roots and create a modified version of one of the default-templates for the user to use. The process for creating the modified default-template is as follows.

Determine which default-template matches the existing unit-tests the best. The system will scan the user's existing tests and determine which default-template is the best match. The system will consider the following attributes of the existing-tests to decide this.
The language (Java or Groovy) in which the existing tests are written.
The @RunWith annotation(s) on the test-classes; this will be used to determine if the module uses the AndroidJUnitRunner, RobolectricTestRunner, MockiotJUnitRunner, etc.; e.g. the presence of the @RunWith (AndroidJUnitRunner.class) on most of the tests indicates the best-match template would be the AndroidJUnit4.java.ft template.
The system will also check for @RunWith(class) annotations that contain a class that is a sub-class of one of the aforementioned test-runners; e.g. the user has extended the RobolectricTestRunner to modify its behavior and uses that in all of their unit-tests; the Robolectric3Mockito template would be the best-match default-template to use in this case.
The system will also identify base-classes that the existing test-classes inherit from and scan them for @RunWith annotations as well.

Copy the default-template to a new Template and make changes to match the user's existing test-classes. The system will copy the default-template code to a new Template (in an in-memory velocity file until the user opts to save it) and apply changes as follows.

Detect if the existing test-classes inherit from a common base-class. The system will determine if the majority (or perhaps plurality) of the existing unit-tests inherit from a common base-class. If they do, it will modify the template to have the test-class extend the common base-class.

Detect if the existing unit-tests use custom annotations or arguments in their annotations. The system will detect if the majority (or perhaps plurality) of the existing unit-tests have common arguments in their annotations. These include
The @RunWith (test-runner-class) annotation: check to see if it has a custom test-runner-class. The system will modify the @RunWith annotation in the new Template to have a @RunWith annotation that uses this custom test-runner-class.
The @Config annotation from the Robolectric framework (org.robolectric.annotation.Config): the system will look for common fields in the @Config annotation and add those that a majority (or perhaps plurality) of the existing-unit-tests have to the Template.

Detect if the existing unit-tests instantiate dependencies of particular types in a common way. The system will determine if the existing unit-tests instantiate certain dependencies for the classes they are testing in the same-way; e.g. consider a case where most existing-unit-tests provide an instance of TestDataStore to all the source-classes that require an instance of a DataStore.
The system will add these classes and the code used to instantiate them to the initExpressionOverrides in the QuickSettings section of the Template.
   Feature: Scan and Add initExpressionOverrides to the User's Template

The system will show a menu option called: “Scan existing tests and recommend initExpressionOverrides.” The system will allow the user to select a test-sources-root. It will then scan the tests in sources root to identify dependencies in the test-classes' corresponding the source-classes that are initialized with the same expressions; e.g. if instances of ServiceAdapter are instantiated with an expression like: TestUtils.createFakeServiceAdapter( )>50% of the time. The system will then offer to create an entry in initExpressionOverrides similar to the following for each such dependency.

```
#set($initExpressionOverrides[“com.myapp.ServiceAdapter”] = {
  “initExpression” : “TestUtils.createFakeServiceAdapter( ) ”,
  “importsRequired” : [“import com.myapp.testutils.TestUtils;”],
  “shouldStoreInReference” : true })
```

The user will have the option to select which entries to include via checkboxes or some other interface; the system will then open some editor-window-user-interface showing the code for the template selected for the module; square-test will add the entries selected by the user to the template-code. The user will then click “Save” or “Save As” to save the template.

### Offer a Quick-Settings Option to Generate Tests for Getter/Setter Pairs

The code in the default templates can be updated easily to generate the tests shown in Appendix: Getter and Setter Test Example if a new Quick Settings option to generate tests for getter/setter pairs is enabled.

The system default-templates will contain a Quick Settings option to generate tests for getter/setter pairs. When set, this will generate tests that verify calling the setter with a given value updates the object such that subsequent calls to the getter return the new value; an example is shown in Appendix: Getter and Setter Test Example.

The system will update the Method to add the following properties to methods that are simple getters or setters¹. ¹ Simple-getter: a method is a simple-getter if the IntelliJ API: PropertyUtil.isSimpleGetter(psiMethod) returns true. A simple-setter: a method is a simple-setter if the IntelliJ API: PropertyUtil.isSimpleSetter(psiMethod) returns true.

| Property Name | Property Type | Mutable | Notes |
|---|---|---|---|
| relatedMemberField | ClassMember | No | Contains a reference to the member |
| | | | field for which this is a getter, |
| | | | setter, or null if the method |
| | | | is not a getter or setter. |

Similarly, the ClassMembers contained in the relatedMemberField described above will have the following properties.

| Property Name | Property Type | Mutable | Notes |
|---|---|---|---|
| getter | Method | No | Contains a reference to the method that |
| | | | is a simple-getter for this field or |
| | | | null if there is not one. |
| setter | Method | | Contains a reference to the method that |
| | | | is a simple-setter for this field or |
| | | | null if there is not one. |

### Adding Additional Test Methods

Software engineers writing Java code organize their code into components (classes). They typically create a test-class for each component (source-class) they create in order to verify the source-class works as expected. The test-class typically contains test-methods; each test-method tests one of the methods in the source-class.

Software engineers typically need to add additional methods to their source-classes for a variety of reasons; e.g. to add additional functionality to the product/service they are building. After adding the new method(s) to the source-class, engineers need to add corresponding test-methods to the test-class. To add a test-method to a test-class, engineers typically type the method by hand or use the create-test-method feature in their IDEs. The create-test-method feature in the IntelliJ IDEA IDE is described below.

A user can add a test-method to a test-class by doing the following in IntelliJ IDEA:
1. Invoke the keyboard shortcut to bring up the Generate context menu.
2. Select the Test Method option.
3. This will either create a test-method or show a list of velocity templates the user can choose from to use to create the test-method. The user can configure how the test-method is created by creating and using a custom velocity template.

This approach has several limitations. The velocity template used to create the test-method does not have access to enough information about the test-class and corresponding source-class to be able to generate a lot of the boilerplate code typically required in a test-method; i.e. code to declare local variables for the method's arguments, invoke the method, and compare the returned result to an expected result. Also, the user must type the full test-method name, which can be quite long.

The smart test generation system will suggest test-methods to create as the user starts typing in a test-class, in a location where it is appropriate to create a test-method; the logic to determine which test-method-suggestions to show is described herein. The test-methods shown will be filtered based on the text the user has typed. When the user selects a test-method, the system will add it to the test-class.

The test-method will be rendered using techniques similar to those used to render the test-methods in the test-class described herein, e.g., the test-method will contain code that declares local fields for the arguments required by the corresponding source-class method (source-method) it is testing; the local fields of commonly-used types will be initialized to appropriate default-values or null; the test-method will store the method's returned-value and also include an assertEquals method call or Groovy assert expression to compare the returned-value to an expected value, etc.

Key differences in the processes used to render the test-methods in the test-class and those used to render a standalone test-method are as follows:
1. The annotation placed on top of the test-method will be selected based on what the system considers to be the best test-framework to use to create the method in the given test-class; the logic the system uses to determine this is described herein.
2. The setup, run-test, and verify-results comments in the test-method will be determined based on logic described herein.
3. The assertEquals expression will be determined based on what the system considers to be the best test-framework to use to create the method in the given test-class. The logic the system uses to determine this is described herein.
4. The name of the test-class member containing the instance of the source-class will be determined by searching the test-class code for a member of the same type as the source-class.

The following paragraphs describe the steps that occur when the user starts typing in a Java or Groovy class. First, the system determines whether the class is a test class. The system will look at the name of the current class (or top-level class in the current file, or first class in the current file if the file is a Groovy file), whether or not the file is in the test-sources directory, and any annotations and super-types (classes or interfaces it extends or implements) in order to determine if the file contains a test-class. A file is considered to contain a test-class if both of the following are true:
1. The name ends in Test or Tests.
2. The file containing the test-class is in a test-sources directory.

Next, the system determines which source-class the current test-class is testing. The system will attempt the following to determine which source-class the current test-class is testing:
1. Search the test-class for a member whose name ends with the string “underTest”; if such a member is found, assume that field's class is the source-class this test-class is testing.
2. If no such member is found, check to see if the test-class's canonical name ends in any known, test-class suffixes; if it does, remove the suffix and search for a class with the new name; e.g. if the test-class's canonical name is com.foo.FooTest, search for com.foo.Foo.
   a. If a class is found, consider that to be the source-class.
   b. Note that known suffixes include but are not limited to: “Integration Test”, “Integration Tests”, “UnitTest”, “UnitTests”, “Test”, “Tests”.
3. If no source-class was found in 2, repeat 2 but search for the class's name instead of canonical name; e.g. instead of searching for com.foo.Foo, search for Foo and return the first class found with that name.
4. If no test-class was found in 1-3, exit the flow.

Next, the system determines which test-methods to suggest. The system will suggest a test-method for each method in the source-class with package-local access or higher (public, protected, package-local access). The system may suggest test-methods for methods in the source-class's super-types (classes or interfaces the source-class is a subclass of) in certain cases; whether or not the system suggests test-methods for super-types may be configurable in the system settings described herein.

Next, the system determines which Test Framework to use. The system will determine the best test framework to use to create the test-methods by doing the following:
1. Determine the test-framework used in the test-class. The system will examine the following to determine the test-framework used in the current test-class: the import statements in the file containing the class, the annotations on the class, the annotations on the class's methods, and the class's super-type(s). For example, if the class contains a method annotated with the @Test annotation from package: org.junit.jupiter.api, the system will determine that the JUnit5 test framework should be used.
2. Determine the test-framework from the system Project/Module Settings. If the system was unable to determine the test-framework used in the test-class, the system will try to determine the test-framework from the system Project/Module Settings. The system will determine which velocity template it would use to create a test-class for the given source-class if the user were to invoke the generate-test-action for the corresponding source-class. The system will check the system project-settings and/or module-settings for the source-class's containing module to determine the appropriate template to use; the system project-settings and module-settings are described herein. The system will then inspect the velocity template (if one is determined) to determine which test-framework is used in the template. If the velocity template is one of the default templates included with the system, the system will use its corresponding test-framework; e.g. if the template is the JUnit4Mockito.java.ft template, the system will use the JUnit4 test-framework. Otherwise, the system will examine the following parts of the template code to determine the test-framework used: the import statements in the template, the annotations on the class defined in the template, the annotations on the method declarations in the template, and the class's super-type(s)

Next, the system determines the test-framework(s) available on the current test classpath. If the system was unable to determine which test-framework to use via the methods described above, the system will examine the test-framework(s) available on the test-class's containing module's test classpath. The system will use logic similar to the following:
1. If JUnit5 is available, the system will use the JUnit5 framework.
2. If JUnit4 is available, the system will use the JUnit4 framework.
3. If TestNG is available, the system will use the TestNG framework.
4. Otherwise, the system will use the JUnit4 framework.

Next, the system determines the comments to use in each section of the test method. The system needs to determine which comments to use before the setup, run, and verify sections of the test-method. The system will determine which velocity template it would use to create a test-class for the given source-class if the user were to invoke the generate-test-action for the source-class. If a velocity template is determined, The system will read the template and look for the following lines:
1. A line containing a Java comment followed by a Velocity comment that contains text: sq_hint: setup_comment.
2. A line containing a Java comment followed by a Velocity comment that contains text: sq_hint: run_comment.
3. A line containing a Java comment followed by a Velocity comment that contains text: sq_hint: verify_comment.

If 1 is found, the system will use the Java comment preceding the velocity comment mentioned in 1 as the setup-section comment to use when rendering the test-method. If 2 is found, the system will use the Java comment preceding the velocity comment mentioned in 2 as the run-section comment to use when rendering the test-method. If 3 is found, the system will use the Java comment preceding the velocity comment mentioned in 3 as the verify-section comment to use when rendering the test-method. If one of the above lines is missing from the template, the system will use a default comment for its corresponding comment-line in the generated test-method.

The way the system adds additional test methods may be further enhanced as described in the following paragraphs.

In some embodiments, the system suggests test-methods for exception cases. The system will suggest a test-method for each exception that could be thrown by dependencies a given source-method interacts with. The logic for determining which dependencies a method interacts with is described herein. Note that the logic for determining how to refer to the dependencies in the test-class code (their test-class member-names) described herein will be different in this case, as described in the next section.

In order to determine how to refer to a given dependency (in the source class) from the test-class code, the system will consider the following additional pieces of information in the test-class's code:
1. How the instance of the source-class is constructed, including
   a. which test-class-members are used in the source-class constructor invocation; the system will use this along with analysis of the constructor code to determine which dependencies were assigned to the test-class-members provided in the constructor arguments.
   b. If the test-class member containing the instance of the source-class is annotated with the @InjectMocks annotation, the system will look at the test-class-members annotated with @Mock as well as the source-class constructor and any dependency-annotated fields in the source-class to determine which dependencies the test-class-members were assigned to.
2. If the source-class's member was set directly in the test-class code; e.g. with code like: “fooUnderTest.dataStore=mockDataStore;”, the system will determine that it should refer to the dependency either with direct field access or by using the test-class-member on the right-hand side of the assignment expression if one is present.
3. If the source-class's member was set by calling the setter-methods in the test-class code; e.g. calling a method like “fooUnderTest.setDataStore(mockDataStore)”, the system will know the field passed as an argument to the setter provided the value to the source-class dependency set in the setter-method-code.

In some embodiments, the system adds stubs for dependency interactions. The system can automatically generate Mockito stubs in the generated test-method. This is similar to the feature described above. The logic for determining which dependencies a method interacts with are similar to those described in the previous paragraph.

### Appendix—Template Data Model

The following is the data model (variables) available to the velocity templates used to create the test-class. The types are described in detail in the next section: Template Variable Types.

| Name | Type | Description |
|---|---|---|
| $sourceClass | SourceClass | Describes the class for which the test is being generated |
| $importsLinesRequired | Set<String> | Import lines required by various components in the SourceClass |
| $StringUtils | StringUtils | The StringUtils class from Apache Commons Lang 3 |
| $CodeStyleUtils | CodeStyleUtils | The CodeStyleUtils class provides methods for obtaining recommended names for fields based |
| | | on the IDE code-style settings. |
| $ListUtils | ListUtils | The ListUtils class provides methods for performing operations on Lists. |

| | | |
|---|---|---|
| Property Name | Type | Description |

SourceClass

| | | |
|---|---|---|
| name | String | Contains the name of the source class. |
| packageName | String | Contains the package-name from the package-declaration statement in source |
| | | class. |
| type | Type | Contains the type of the source class. |
| testClassMemberName | String | Mutable field containing the name of the member used to store an instance |
| | | of the source class. The default value is determined by the IDE code- |
| | | style settings. |
| preferredConstructor | Constructor | Mutable field that, by default, contains longest constructor (constructor |
| | | with the most arguments) with at least package-local access or higher |
| | | (Public, Protected or Package Local). |
| publicConstructors | List<Constructor> | All public constructors in the source class, including the default- |
| | | constructor provided by the java language spec if applicable. |
| protectedConstructors | List<Constructor> | All protected constructors in source class. |
| packageLocalConstructors | List<Constructor> | All package-local constructors in source class. |
| privateConstructors | List<Constructor> | All private constructors in source class |
| constructors | List<Constructor> | Contains all constructors in the class, including the default-constructor |
| | | provided by the java language spec if applicable. |
| publicInstanceMethods | List<Method> | All public instance methods in the source class |
| protectedInstanceMethods | List<Method> | All protected instance methods in the source class |
| packageLocalInstanceMethods | List<Method> | All package-local instance methods in the source class |
| privateInstanceMethods | List<Method> | All private instance methods in the source class |
| instanceMethods | List<Method> | All instance methods in the source class. |
| staticMethods | List<Method> | All static methods in the source class |
| publicStaticMethods | List<Method> | All public static methods in the source class |
| protectedStaticMethods | List<Method> | All protected static methods in the source class |
| packageLocalStaticMethods | List<Method> | All package local static methods in the source class |
| privateStaticMethods | List<Method> | All private static methods in the source class |
| packageVisibleStaticCreatorMethods | List<Method> | Contains all static methods that return an instance of source class |
| | | and have package-local access or higher. |
| publicInstanceFields | List<ClassMember> | Contains all public instance fields in source class. |
| protectedInstanceFields | List<ClassMember> | Contains all protected instance fields in source class. |
| packageLocalInstanceFields | List<ClassMember> | Contains all package-local instance fields in source class. |
| privateInstanceFields | List<ClassMember> | Contains all private instance fields in source class. |
| staticFields | List<ClassMember> | Contains all static fields in source class. |
| publicStaticFields | List<ClassMember> | Contains all public static fields in source class. |
| protectedStaticFields | List<ClassMember> | Contains all protected static fields in source class. |
| packageLocalStaticFields | List<ClassMember> | Contains all package-local static fields in source class. |
| privateLocalStaticFields | List<ClassMember> | Contains all private static fields in source class. |
| dependencyAnnotatedFields | List<ClassMember> | Contains all fields with a dependency-annotation (@Inject or |
| | | @Autowired). |
| fields | List<ClassMember> | Contains all fields (static and instance) in the source class |
| enum | boolean | True if source class is an enum. |
| enumFirstValue | String | Contains the first value in the enum if source class is an enum; |
| | | otherwise, returns null. |
| enumValues | List<String> | Returns the values in the enum if source class is an enum; |
| | | otherwise, returns the empty list. |
| singleton | boolean | True if source class is a singleton; false otherwise. |
| singletonAccessExpression | String | The expression needed to access the instance of the singleton if |
| | | source class is a singleton; e.g. getInstance( ), instance( ), |
| | | INSTANCE; null otherwise. |
| abstract | boolean | True if source class is abstract. |
| abstractClassBody | String | Contains the body of an anonymous instance of the abstract-class |
| | | that contains stubs for all of the abstract methods. |
| hasGenerics | boolean | True if source class has one or more type-parameters. |

### Appendix—Template Variable Types

| Method | | |
|---|---|---|
| Property Name | Type | Description |
| name | String | The name of the method |
| parameters | List<Variable> | The method's parameters |
| public | boolean | True if the method is public; |
| | | false otherwise. |
| protected | boolean | True if the method is protected; |
| | | false otherwise. |
| packageLocal | boolean | True if the method is package- |
| | | local; false otherwise. |
| private | boolean | True if the method is private; |
| | | false otherwise. |
| static | boolean | True if the method is static. |
| abstract | boolean | True if the method is abstract. |
| native | boolean | True if the method is native. |
| simpleGetter | boolean | True if the method is a simple- |
| | | getter. |
| simpleSetter | boolean | True if the method is a simple- |
| | | setter. |
| simpleGetterOrSetter | boolean | True if the method is a simple- |
| | | getter or a simple-setter. |
| constructor | boolean | True if the method is a |
| | | constructor. |
| returnType | Type | The return-type of the method |
| | | or null if the method has none. |
| throwsException | boolean | True if the method throws an |
| | | exception. |
| overloadSuffix | String | The suffix to append to the |
| | | test-method name to avoid |
| | | method-name conflicts in the |
| | | test-class. |

Constructor
Constructor is the same as Method, but implements Comparable<Constructor> such that it is ordered by number of parameters.

| Variable | | |
|---|---|---|
| Property Name | Type | Description |
| declaredName | String | The declared name for the variable; For ClassMembers this |
| | | property contains the name of the member it was created from; |
| | | for method-parameters, this contains the name of the parameter. |
| declaredNameWithoutPrefix | String | The declaredName with any prefixes removed; for method- |
| | | parameters, this is just the declaredName; for ClassMembers, |
| | | this is the name with any recognized leading prefix (_, _{——}, |
| | | m, my, our) removed. |
| final | boolean | True if the variable is declared final. |
| type | Type | The Type of the variable. |
| defaultInitExpression | String | This is an alias for type.defaultInitExpression. |
| initExpression | String | This is an alias for type.initExpression. |
| shouldBeMocked | boolean | This is an alias for type.shouldBeMocked. |
| shouldStoreIn Reference | boolean | Set to true by default; this may be modified by logic in the |
| | | template code based on the Quick Settings. |
| testClassMemberName | String | For ClassMembers, this is the same as the declaredName; for method- |
| | | parameters, this is determined based on the declared-name and/or |
| | | the output of JavaCodeStyleManager.suggestVariableName( ) API; |
| | | this may be modified by logic in the template code based on the |
| | | Quick Settings. |
| testClassLocalFieldName | String | For method-parameters, this is the same as the declared-name. For |
| | | ClassMembers, this is determined based on the declared-name and/or |
| | | the output of JavaCodeStyleManager.suggestVariableName( ) API; |
| | | this may be modified by logic in the template code based on the |
| | | Quick Settings. |

| ClassMember | | |
|---|---|---|
| Name | Type | Description |
| Everything in Variable | N/A | N/A |
| public | boolean | True if the member field is public |
| protected | boolean | True if the member field is protected |
| packageLocal | boolean | True if the member field is package- |
| | | local |
| private | boolean | True if the member field is private |
| static | boolean | True if the member field is static. |
| dependencyAnnotated | boolean | True if the member field is |
| | | dependency-annotated (annotated with |
| | | @Inject or @Autowired). |
| final | boolean | True if the member field is final. |

| Type | | |
|---|---|---|
| Name | Type | Description |
| canonicalName | String | Contains the canonical name of the type |
| | | or null if the type has no canonical |
| | | name, or the canonical name could not |
| | | be determined. |
| canonicalText | String | Contains the canonical text of the type. |
| mockable | boolean | True if the type is mockable (non- |
| | | final, non-static, not an array and |
| | | not an enum) |
| array | boolean | True if the type is an array; false |
| | | otherwise. |
| defaultInitExpression | String | The default expression used to obtain |
| | | an instance of the type or “null” if the |
| | | type is not a recognized Common Type. |

| Type | | |
|---|---|---|
| Name | Type | Description |
| initExpression | String | Set to defaultInitExpression by default. This |
| | | may be modified by the template-code; see |
| | | the Quick Settings initExpressionOverrides |
| | | for details. |
| shouldBeMocked | boolean | This is set to false when the type is a |
| | | recognized Common Type. For other types is |
| | | set to true if the type is mockable and false |
| | | otherwise. |

| CodeStyleUtils | Return | |
|---|---|---|
| Method | Type | Description |
| suggestMemberName(String | String | Returns the suggested name |
| className) | | to use for a member of type |
| | | className based on the |
| | | IDE code-style settings. |
| suggestLocalFieldName(String | String | Returns the suggested name |
| className) | | to use for a local-field of |
| | | type className based on the |
| | | IDE code-style settings. |

| ListUtils | Return | |
|---|---|---|
| Method | Type | Description |
| filter(List<?> | List<?> | Returns a new list containing items in |
| theList, String | | the given list that have a property with |
| attributeName, | | attributeName that contains attributeValue. |
| Object | | |
| attributeValue) | | |
| max(List<T> | T | Returns the max item in the list as |
| theList) | | determined by the items' implementations |
| | | of compareTo(T). Type T must implement |
| | | Comparable<? super T>. |
| min(List<T> | T | Returns the min item in the list as |
| theList) | | determined by the items' implementations |
| | | of compareTo(T). Type T must implement |
| | | Comparable<? super T>. |

StringUtils
This is the StringUtils class from Apache Commons Lang 3.6.

### Appendix—Default Types JSON File

Following are default types.

```
{
  “boolean”: {
    “canonicalName”: “boolean”,
    “initExpression”: “false”,
    “importsRequired”: [ ],
    “isMockable”: false
  },
  “byte”: {
    “canonicalName”: “byte”,
    “initExpression”: “0b0”,
    “importsRequired”: [ ],
    “isMockable”: false
  },
  “char”: {
    “canonicalName”: “char”,
    “initExpression”: “‘a’”,
    “importsRequired”: [ ],
    “isMockable”: false
  },
  “android.util.Pair”: {
    “canonicalName”: “android.util.Pair”,
    “initExpression”: “android.util.Pair.create(null, null)”,
    “importsRequired”: [ ],
    “isMockable”: false
  },
  “com.google.common.collect.ArrayListMultimap”: {
    “canonicalName”: “com.google.common.collect.ArrayListMultimap”,
    “initExpression”:
“com.google.common.collect.ArrayListMultimap.create( )”,
    “importsRequired”: [ ],
    “isMockable”: false
  },
  “com.google.common.collect.ArrayTable”: {
    “canonicalName”: “com.google.common.collect.ArrayTable”,
    “initExpression”:
“com.google.common.collect.ArrayTable.create(java.util.Arrays.asList( ),
java.util.Arrays.asList( ))”,
    “importsRequired”: [ ],
    “isMockable”: false
  },
  “com.google.common.collect.BiMap”: {
    “canonicalName”: “com.google.common.collect.BiMap”,
    “initExpression”:
“com.google.common.collect.HashBiMap.create(com.google.common.collect.I
mmutableMap.of( ))”,
    “importsRequired”: [ ],
    “isMockable”: true
  },
}
```

### Appendix—Default Template: JUnit4Mockito.java.ft

The following is the code for the Junit4Mockito.java.ft template included with the system.

### Appendix—Stub Example

This shows various test-classes generated for the source-class shown below. The Source Class section shows a sample java file the user may have in his/her module. The Test Class from the current version of the system section shows the test-class the current version of the system would generate for the source-class. The With DependencyInteraction Stubs section shows the test-class the system would generate if the feature to generate stubs for DependencyInteractions was implemented. The “With tests for exceptions thrown by DependencyInteractions” section shows the test-class the system would generate if the feature to generate test-methods for each (Method, Dependencyinteraction that contains a method that throws a checkedException) combination was implemented.

Source Class -

```
package com.myapp;
import javax.annotation.Nonnull;
import java.io.IOException;
import java.sql.SQLException;
import java.util.Collections;
import java.util.List;
public class Foo {
  @Nonnull
  private final DataStore mDataStore;
  public Foo(@Nonnull DataStore dataStore) {
    mDataStore = dataStore;
  }
  public List<User> getAllUsersMatchingGender(final String gender) {
    try {
      return mDataStore.getUsers( );
    } catch (IOException e) {
      return Collections.emptyList( );
    }
  }
  public void storeUser(final User user) {
    try {
      mDataStore.putUser(user);
    } catch (IOException e) {
      throw new RuntimeException(e);
    } catch (SQLException e) {
      throw new RuntimeException(e);
    }
  }
}
```

This is the test-class generated by the system by invoking the Generate Test Action on the source-class shown above.

```
package com.myapp;
import org.junit.Before;
import org.junit.Test;
import org.mockito.Mock;
import java.util.List;
import static org.mockito.MockitoAnnotations.initMocks;
public class FooTest {
  @Mock
  private DataStore mockDataStore;
  private Foo fooUnderTest;
  @Before
  public void setUp( ) {
    initMocks(this);
    fooUnderTest = new Foo(mockDataStore);
  }
  @Test
  public void testGetAllUsersMatchingGender( ) {
    // Setup
    final String gender = “gender”;
    // Run the test
    final List<User> result =
fooUnderTest.getAllUsersMatchingGender(gender);
    // Verify the results
  }
  @Test
  public void testStoreUser( ) {
    // Setup
    final User user = null;
    // Run the test
    fooUnderTest.storeUser(user);
    // Verify the results
  }
}
```

This is a sample test-class with the stub-code generated for each Dependencyinteraction that has a return type. The differences between this and the file generated by the current version of the system are highlighted.

```
package com.myapp;
import org.junit.Before;
import org.junit.Test;
import org.mockito.Mock;
import java.util.Collections;
import java.util.List;
import static org.mockito.Mockito.when;
import static org.mockito.MockitoAnnotations.initMocks;
public class FooTest {
  @Mock
  private DataStore mockDataStore;
  private Foo fooUnderTest;
  @Before
  public void setUp( ) {
    initMocks(this);
    fooUnderTest = new Foo(mockDataStore);
  }
  @Test
  public void testGetAllUsersMatchingGender( ) throws Exception {
    // Setup
    final String gender = “gender”;
when(mockDataStore.getUsers( )).thenReturn(Collections.emptyList( ));
    // Run the test
    final List<User> result =
fooUnderTest.getAllUsersMatchingGender(gender);
    // Verify the results
  }
  @Test
  public void testStoreUser( ) {
    // Setup
    final User user = null;
    // Run the test
    fooUnderTest.storeUser(user);
    // Verify the results
  }
}
```

This is the test-class with the test-methods generated for each exception thrown by each DependencyInteraction in the methods being tested. The differences between this and the file generated by the current version of the system are highlighted.

```
package com.myapp;
import org.junit.Before;
import org.junit.Test;
import org.mockito.Mock;
import java.io.IOException;
import java.sql.SQLException;
import java.util.Collections;
import java.util.List;
import static org.mockito.ArgumentMatchers.any;
import static org.mockito.Mockito.doThrow;
import static org.mockito.Mockito.when;
import static org.mockito.MockitoAnnotations.initMocks;
public class FooTest {
  @Mock
  private DataStore mockDataStore;
  private Foo fooUnderTest;
  @Before
  public void setUp( ) {
    initMocks(this);
    fooUnderTest = new Foo(mockDataStore);
  }
  @Test
  public void testGetAllUsersMatchingGender( ) throws Exception {
    // Setup
    final String gender = “gender”;
when(mockDataStore.getUsers( )).thenReturn(Collections.emptyList( ));
    // Run the test
    final List<User> result =
fooUnderTest.getAllUsersMatchingGender(gender);
    // Verify the results
  }
  @Test
  public void
testGetAllUsersMatchingGender_DataStoreThrowsIOException( ) throws
Exception {
    // Setup
    final String gender = “gender”;
    when(mockDataStore.getUsers( )).thenThrow(new IOException( ));
    // Run the test
    final List<User> result =
fooUnderTest.getAllUsersMatchingGender(gender);
    // Verify the results
  }
  @Test
  public void testStoreUser_ThrowsIOException( ) throws Exception {
    // Setup
    final User user = null;
    doThrow(new
IOException( )).when(mockDataStore).putUser(eq(user));
    // Run the test
    fooUnderTest.storeUser(user);
    // Verify the results
  }
  @Test
  public void testStoreUser_DataStoreThrowsSQLException( ) throws
Exception {
    // Setup
    final User user = null;
    doThrow(new
SQLException( )).when(mockDataStore).putUser(eq(user));
    // Run the test
    fooUnderTest.storeUser(user);
    // Verify the results
  }
}
```

### Appendix—Getter and Setter Test Example

The following is a sample source-class a user might have in his/her code base.

```
package com.myapp;
import java.util.Date;
public class Foo {
  private String name;
  private Date dateOfBirth;
  public Foo(String name, Date dateOfBirth) {
    this.name = name;
    this.dateOfBirth = dateOfBirth;
  }
  public String getName( ) {
    return name;
  }
  public void setName(String name) {
    this.name = name;
  }
  public Date getDateOfBirth( ) {
    return dateOfBirth;
  }
  public void setDateOfBirth(Date dateOfBirth) {
    this.dateOfBirth = dateOfBirth;
  }
}
```

The following shows the test-class the current version of the system would create for the source-class above.

```
package com.myapp;
public class FooTest {
  private String name;
  private Date dateOfBirth;
  private Foo fooUnderTest;
  @Before
  public void setUp( ) {
    name = “name”;
    dateOfBirth = new GregorianCalendar(2017, 1, 1).getTime( );
    fooUnderTest = new Foo(name, dateOfBirth);
  }
}
```

The following shows the test-class generated when the Quick Settings option to generate tests for getter-and-setter-pairs is enabled. The new test-methods are highlighted.

```
package com.myapp;
import org.junit.Before;
import org.junit.Test;
import java.util.Date;
import java.util.GregorianCalendar;
import static org.junit.Assert.assertEquals;
public class FooTest {
  private String name;
  private Date dateOfBirth;
  private Foo fooUnderTest;
  @Before
  public void setUp( ) {
    name = “name”;
    dateOfBirth = new GregorianCalendar(2017, 1, 1).getTime( );
    fooUnderTest = new Foo(name, dateOfBirth);
  }
  @Test
  public void testGetSetName( ) {
    // Setup
    final String name = “name”;
    // Run the test
    fooUnderTest.setName(name);
    final String result = fooUnderTest.getName( );
    // Verify the results
    assertEquals(name, result);
  }
  @Test
  public void testGetSetDateOfBirth( ) {
    // Setup
    final Date dateOfBirth = new GregorianCalendar(2017, 1,
1).getTime( );
    // Run the test
    fooUnderTest.setDateOfBirth(dateOfBirth);
    final Date result = fooUnderTest.getDateOfBirth( );
    // Verify the results
    assertEquals(dateOfBirth, result);
  }
}
```

From the foregoing, it will be appreciated that specific embodiments of the system have been described herein for purposes of illustration, but that various modifications may be made without deviating from the spirit and scope of the invention.

I/We claim:

1. A computer-implemented method to automatically generate unit tests, the method comprising:
receiving a selection of a subject class for which a developer wants to generate test code in a test class automatically;
identifying a template to use for generating test code;
generating mock dependency classes by identifying dependencies of the selected class, determining which dependencies have non-mocks available, and initializing mocks for those dependencies that do not have non-mocks available;
creating test methods for subject methods in the selected subject class;
selecting variable values in each created test method needed to pass to the subject method being tested;
generating code in the test method to verify output after calling the subject method; and
generating the test class with the created test methods, selected variable values, and generated output verification code,
wherein the preceding steps are performed by at least one processor.

2. The method of claim 1 wherein receiving the selection comprises the developer selecting the subject class in a graphical user interface.

3. The method of claim 1 wherein while receiving the selection, if this is a first time the developer has tried to generate a test class for this module, then the system requests that the user provide configuration information that will be used to generate this and subsequent unit tests.

4. The method of claim 1 wherein identifying the template comprises asking the developer to select from among multiple available templates.

5. The method of claim 1 wherein generating mock dependency classes comprises initializing mocks to take the place of dependencies that are normally called during operation of the code being tested, wherein the mocks provide well determined responses from the dependencies to test the code of the selected class.

6. The method of claim 1 wherein creating test methods comprises identifying public, package local, and protected methods of the subject class, and generating test methods for each identified method that is accessible.

7. The method of claim 1 wherein selecting variable values comprises selecting non-null, non-empty values that the developer can modify to make the generated test exercise the functionality intended by the developer for that test.

8. The method of claim 1 wherein generating code to verify output comprises testing a return value returned from the subject method.

9. The method of claim 1 wherein generating the test class comprises asking the developer where to store the generated test class.

10. A computer system for generating detailed test code that relieves a developer from writing boilerplate code, the system comprising:
a processor and memory configured to execute software instructions embodied within the following components;
a class selector that receives a selection of a subject source code class within a project for which the developer wants to generate test code in a test class;
a template manager that presents one or more templates to the developer for generating the test class;
a mock generator that identifies dependencies of the selected class, determines which dependencies have non-mocks available, and initializes mocks for those dependencies that do not have non-mocks available;
a test method generator that creates test methods to test subject methods in the selected subject class;
a variable value selector that initializes local variables in each created test method needed to pass to the subject method being tested;
a result verifier that generates code in the test method to verify output from calling the subject method; and
a test class generator that generates the test class by writing the test code that results from generating test methods into source code files representing test cases.

11. The system of claim 10 wherein the class selector receives the selection via a menu item or keyboard shortcut.

12. The system of claim 10 wherein the class selector determines whether this is a first time the developer selects a class and invokes the system to generate test code for the class, and if it is determined to be the first time, then displaying a user interface to receive default configuration information for future invocations of the system.

13. The system of claim 10 wherein the template manager displays one or more Velocity templates, and wherein the templates contain default information and formatting for the test class.

14. The system of claim 10 wherein the mock generator initializes mocks to take the place of dependencies that are normally called during operation of the code being tested to provide well determined responses from the dependencies to test the code of the selected class.

15. The system of claim 10 wherein the test method generator enumerates the subject methods by inspecting the subject class, identifies relevant qualities of the subject methods, and determines which subject methods can be invoked and tested by the system.

16. The system of claim 10 wherein the variable value selector selects values for the local variables that are useful, readable, and modifiable values to reduce burden on the developer to pass meaningful values to the subject method rather than empty or null values that would not exercise functionality of the subject method as thoroughly.

17. The system of claim 10 wherein the result verifier treats the subject method as a black box, with the variable value selector providing meaningful input to the black box and the result verifier verifying that an expected result comes out of the black box.

18. The system of claim 10 further comprising a pattern recognition component that recognizes patterns in the test code and applies the recognized patterns when generating test code to adhere to the recognized patterns.

19. The system of claim 10 wherein the test class generator recognizes multiple test roots in a project and selects an appropriate test root in which to generate the test class based on the subject class selected.

20. A computer-readable storage medium comprising instructions for controlling a computer system to automatically generate unit tests, wherein the instructions, upon execution, cause a processor to perform actions comprising:
receiving a selection of a subject class for which a developer wants to generate test code in a test class automatically;
identifying a template to use for generating test code;
generating mock dependency classes by identifying dependencies of the selected class, determining which dependencies have non-mocks available, and initializing mocks for those dependencies that do not have non-mocks available;
creating test methods for subject methods in the selected subject class;
selecting variable values in each created test method needed to pass to the subject method being tested;
generating code in the test method to verify output after calling the subject method; and
generating the test class with the created test methods, selected variable values, and generated output verification code,
wherein the preceding steps are performed by at least one processor.
